(19) United States
(12) Patent Application Publication
(10) Pub. No.: US 2011/0176094 A1
(43) Pub. Date: Jul. 21, 2011

(54) Transflective Liquid Crystal Display Device

(76) Inventors: Masateru Morimoto, Mobara (JP); Takahiro Ochiai, Chiba (JP)

(21) Appl. No.: 13/079,124

(22) Filed: Apr. 4, 2011

Related U.S. Application Data
(62) Division of application No. 11/692,256, filed on Mar. 28, 2007.

(30) Foreign Application Priority Data
Apr. 5, 2006 (JP) 2006-103861

(51) Int. Cl. G02F 1/1335; G02F 1/1343

(52) U.S. Cl. 349/106; 349/144

(57) ABSTRACT

A transflective liquid crystal display device including a liquid crystal display panel which includes a pair of substrates; liquid crystal which is sandwiched between the pair of substrates; a plurality of sub pixels each of which includes a transmissive portion and a reflective portion, each sub pixel having a pixel electrode formed on one substrate out of the pair of substrates and a counter electrode formed on the one substrate, the pixel electrode being arranged in common in the transmissive portion and the reflective portion and the counter electrode being arranged individually in the transmissive portion and the reflective portion in one sub pixel, the pixel electrode and the counter electrode generating an electric field therebetween thus driving the liquid crystal. The liquid crystal display panel includes color filters having different lengths or different shape portions, for example.

### CROSS REFERENCE TO RELATED APPLICATION

This application is a divisional application of U.S. application Ser. No. 11/692,256, filed Mar. 28, 2007, the contents of which are incorporated herein by reference.

The present application claims priority from Japanese application JP2006-103861 filed on Apr. 5, 2006, the content of which is hereby incorporated by reference into this application.

### BACKGROUND OF THE INVENTION

1. Field of the invention

The present invention relates to a transflective liquid crystal display device, and more particularly to an IPS-type transflective liquid crystal display device.

2. Description of Related Arts

A transflective liquid crystal display device having a transmissive portion and a reflective portion within 1 sub pixel has been used as a display for a portable equipment.

The transflective liquid crystal display device adopts a vertical electric field method in which an electric field in the direction perpendicular to substrate planes of a pair of substrates is applied to liquid crystal sandwiched between a pair of substrates for driving the liquid crystal. Further, to combine properties of a transmissive portion and a reflective portion, a stepped portion is formed between the transmissive portion and the reflective portion, and a phase difference plate is disposed between a polarizer and a liquid crystal layer.

As the liquid crystal display device, an IPS-type liquid crystal display device has been known. In the IPS-type liquid crystal display device, pixel electrodes (PIX) and counter electrodes (CT) are formed on the same substrate and an electric field is applied between the pixel electrodes (PIX) and counter electrodes (CT) thus rotating the liquid crystal in the substrate plane so as to control contrast. Accordingly, the IPS-type liquid crystal display device is characterized in that the contrast or the tone of a display image when a screen is viewed from the oblique direction is not inverted. To make use of this characteristic, a technique which constitutes the transflective liquid crystal display device using the IPS-type liquid crystal display device has been proposed in the following patent document 1 or the like, for example.

Usually, the IPS-type transmissive liquid crystal display device adopts a normally black display mode. Accordingly, as described in the above-mentioned patent document 1, when the transflective liquid crystal display device is constituted by using the IPS-type liquid crystal display device, for example, when the transmissive portion adopts a normally black display mode, the reflective portion performs a normally white display mode thus giving rise to a drawback that contrast is reversed between the transmissive portion and the reflective portion.

To overcome the above-mentioned drawback, inventors of the present invention filed a Japanese patent application (see following patent document 2) on a transflective liquid crystal display device which has the novel pixel structure.

With respect to this transflective liquid crystal display device of this patent application, as the pixel structure of each sub pixel, with respect to a pixel electrode common to a transmissive portion and a reflective portion, counter electrodes are provided individually to the transmissive portion and the reflective portion, and reference voltages (counter voltages or common voltages) which differ from each other are applied to the common electrodes thus preventing the reversal of the contrast between the transmissive portion and the reflective portion.

Further, in the transflective liquid crystal display device on which the patent application was already filed, the transmissive portion adopts a normally black characteristic (black display in a non-voltage applied state) and the reflective portion adopts a normally white characteristic (a white display in a non-voltage applied state).

[Patent document 1] JP-A-2003-344837
[Patent document 2] Japanese Patent Application 2005-322049

### SUMMARY OF THE INVENTION

As described above, in the transflective liquid crystal display device on which the patent application was already filed, since the reflective portion adopts the normally white characteristic, to perform a black display in the reflective portion, it is necessary to increase a drive voltage applied between the pixel electrode and the counter electrode. However, it is impossible to sufficiently change over the display mode to the black mode in a portion of the reflective portion to which the electric field is hardly applied and hence, a white portion remains as it is whereby there exists a possibility that contrast of the reflective portion is lowered.

The present invention has been made to overcome the above-mentioned drawbacks of the related art and it is an advantage of the present invention to provide a technique which can enhance contrast of a reflective portion in an IPS-type liquid crystal display device in which the reflective portion exhibits the normally white characteristic.

The above-mentioned and other advantages and novel features of the present invention will become apparent by the description of this specification and attached drawings.

To briefly explain the summary of typical inventions among the inventions disclosed in this specification, they are as follows.

(1) A transflective liquid crystal display device has a liquid crystal display panel which includes a pair of substrates; liquid crystal which is sandwiched between the pair of substrates; a plurality of sub pixels each of which includes a transmissive portion and a reflective portion; each sub pixel having a pixel electrode formed on one substrate out of the pair of substrates and a counter electrode formed on one substrate, the pixel electrode being arranged in common in the transmissive portion and the reflective portion and the counter electrode being arranged individually in the transmissive portion and the reflective portion in one sub pixel, the pixel electrode and the counter electrode generating an electric field therebetween thus driving the liquid crystal, wherein the liquid crystal display panel further includes video lines each of which supplies a video voltage to the pixel electrode of each one of the plurality of sub pixels, and a portion of the pixel electrode in the reflective portion is overlapped to the video line when the pixel electrode in the reflective portion and the video line are projected from the direction orthogonal to a main surface of the liquid crystal display panel on one substrate.

(2) A transflective liquid crystal display device has a liquid crystal display panel which includes a pair of substrates; liquid crystal which is sandwiched between the pair of substrates; a plurality of sub pixels each of which includes a transmissive portion and a reflective portion; each sub pixel having a pixel electrode formed on one substrate out of the pair of substrates and a counter electrode formed on one substrate, the pixel electrode being arranged in common in the transmissive portion and the reflective portion and the counter electrode being arranged individually in the transmissive portion and the reflective portion in one sub pixel, the pixel electrode and the counter electrode generating an electric field therebetween thus driving the liquid crystal, wherein the liquid crystal display panel includes color filters, and a length of the color filter in the first direction in the reflective portion of at least one sub pixel out of the plurality of sub pixels is set different from a length of the color filter in the first direction in the transmissive portion of one sub pixel.

(3) A transflective liquid crystal display device has a liquid crystal display panel which includes a pair of substrates; liquid crystal which is sandwiched between the pair of substrates; a plurality of sub pixels each of which includes a transmissive portion and a reflective portion; each sub pixel having a pixel electrode formed on one substrate out of the pair of substrates and a counter electrode formed on one substrate, the pixel electrode being arranged in common in the transmissive portion and the reflective portion and the counter electrode being arranged individually in the transmissive portion and the reflective portion in one sub pixel, the pixel electrode and the counter electrode generating an electric field therebetween thus driving the liquid crystal, wherein the liquid crystal display panel includes color filters, and a shape of the color filter in the reflective portion of at least one sub pixel out of the plurality of sub pixels is displaced in the first direction with respect to a shape of the color filter in the transmissive portion.

(4) A transflective liquid crystal display device has a liquid crystal display panel which includes a pair of substrates; liquid crystal which is sandwiched between the pair of substrates; a plurality of sub pixels each of which includes a transmissive portion and a reflective portion; each sub pixel having a pixel electrode formed on one substrate out of the pair of substrates and a counter electrode formed on one substrate, the pixel electrode being arranged in common in the transmissive portion and the reflective portion and the counter electrode being arranged individually in the transmissive portion and the reflective portion in one sub pixel, the pixel electrode and the counter electrode generating an electric field therebetween thus driving the liquid crystal, wherein the numbers of pixel electrodes in the reflective portions of the sub pixels of first color, second color and third color out of the plurality of sub pixels differ from each other for the respective sub pixels of the first color, the second color and the third color.

(5) In the transflective liquid crystal display device having the constitution (4), the first color is red, the second color is green and the third color is blue, and assuming the numbers of the pixel electrodes in the reflective portions of the sub pixels of red, green and blue as Ra, Ga, Ba, a relationship Ga>Ba>Ra is established.

(6) A transflective liquid crystal display device has a liquid crystal display panel which includes a pair of substrates; liquid crystal which is sandwiched between the pair of substrates; a plurality of sub pixels each of which includes a transmissive portion and a reflective portion; each sub pixel having a pixel electrode formed on one substrate out of the pair of substrates and a counter electrode formed on one substrate, the pixel electrode being arranged in common in the transmissive portion and the reflective portion and the counter electrode being arranged individually in the transmissive portion and the reflective portion in one sub pixel, the pixel electrode and the counter electrode generating an electric field therebetween thus driving the liquid crystal, wherein the liquid crystal display panel includes video lines, and a distance between the pixel electrode in the reflective portion of at least one sub pixel out of the plurality of sub pixels and the video line is set smaller than a distance between the pixel electrode in the transmissive portion of one sub pixel and the video line.

(7) A transflective liquid crystal display device has a liquid crystal display panel which includes a pair of substrates; liquid crystal which is sandwiched between the pair of substrates; a plurality of sub pixels each of which includes a transmissive portion and a reflective portion; each sub pixel having a pixel electrode formed on one substrate out of the pair of substrates and a counter electrode formed on one substrate, the pixel electrode being arranged in common in the transmissive portion and the reflective portion and the counter electrode being arranged individually in the transmissive portion and the reflective portion in one sub pixel, the pixel electrode and the counter electrode generating an electric field therebetween thus driving the liquid crystal, wherein the lengths in the first direction of the sub pixels of first color, second color and third color out of the plurality of sub pixels in the reflective portions differ from each other for the respective sub pixels of the first color, the second color and the third color.

(8) In the transflective liquid crystal display device having the constitution (7), the first color is red, the second color is green and the third color is blue, and assuming the lengths in the first direction of the sub pixels of red, green and blue in the reflective portions as Rl, Gl, Bl, a relationship Gl>Bl>Rl is established.

(9) In the transflective liquid crystal display device having any one of the constitutions (2), (3), (7) and (8), the first direction is a direction along one horizontal display line.

(10) In the transflective liquid crystal display device having any one of the constitutions (1) to (9), in each sub pixel out of the plurality of sub pixels, a potential applied to one counter electrode in one of the transmissive portion and the reflective portion is higher than a potential applied to the pixel electrode, and a potential applied to the counter electrode of another of the transmissive portion and the reflective portion is lower than the potential applied to the pixel electrode.

(11) In the transflective liquid crystal display device having any one of the constitutions (1) to (10), the transmissive portion possesses a normally black characteristic which allows the transmissive portion to perform a black display in a non-voltage applied state and the reflective portion possesses a normally white characteristic which allows the reflective portion to perform a white display in a non-voltage applied state.

(12) In the transflective liquid crystal display device having any one of the constitutions (1) to (11), the counter electrodes are driven independently for every one display line.

(13) In the transflective liquid crystal display device having any one of the constitutions (1) to (12), assuming two neighboring display lines as one display line and another display line, reference voltages which differ from each other are applied to the counter electrodes in the transmissive portions of the respective sub pixels on one display line and the counter electrodes in the reflective portions of the respective sub pixels on one display line respectively, and the same reference voltage is applied to the counter electrodes in the reflective portions of the respective sub pixels on one display line and the counter electrodes in the transmissive portions of the respective sub pixels on another display line respectively.

(14) In the transflective liquid crystal display device having the constitution (13), the counter electrodes in the reflective portions of the respective sub pixels on one display line and the counter electrodes in the transmissive portions of the respective sub pixels on another display line are common electrodes.

(15) In the transflective liquid crystal display device having any one of the constitutions (1) to (14), the counter electrodes are formed of a strip-like electrode, an interlayer insulation film is formed on the strip-like counter electrodes, and the pixel electrodes are formed on the interlayer insulation film.

To briefly explain advantageous effects obtained by the typical inventions among the inventions described in this specification, they are as follows.

That is, according to the present invention, in the IPS-type transflective liquid crystal display device in which each sub pixel has the reflective portion possessing a normally white characteristic, it is possible to enhance contrast of the reflective portions.

### BRIEF DESCRIPTION OF THE DRAWINGS

FIG. 1 is a plan view showing the electrode structure of sub pixels of a transflective liquid crystal display device of an embodiment 1 according to the present invention;

FIG. 2 is a cross-sectional view of an essential part showing the cross-sectional structure taken along a connection line A-A′ in FIG. 1;

FIG. 3 is a cross-sectional view of an essential part showing the cross-sectional structure taken along a connection line B-B′ in FIG. 1;

FIG. 4 is a graph showing voltage-reflectance characteristics of a reflective portion of a transflective liquid crystal display device of an embodiment 1 of the present invention and a reflective portion of a transflective liquid crystal display device which becomes a premise of the present invention;

FIG. 5 is a plan view showing the electrode structure of sub pixels of a transflective liquid crystal display device of an embodiment 2 of the present invention;

FIG. 6 is a plan view showing the electrode structure of sub pixels of a transflective liquid crystal display device of an embodiment 3 of the present invention;

FIG. 7 is a plan view showing the electrode structure of sub pixels of a transflective liquid crystal display device which becomes a premise of the present invention;

FIG. 8 is a cross-sectional view of an essential part showing the cross-sectional structure taken along a connection line A-A′ in FIG. 7;

FIG. 9 is a cross-sectional view of an essential part showing the cross-sectional structure taken along a connection line B-B′ in FIG. 7;

FIG. 10 is a cross-sectional view of an essential part showing the cross-sectional structure taken along a connection line C-C′ in FIG. 7; and

FIG. 11 is a view showing a reference voltage applied to a counter electrode in a transmissive portion and a counter electrode in a reflective portion in a transflective liquid crystal display device which becomes the premise of the present invention.

### DETAILED DESCRIPTION OF THE INVENTION

Hereinafter, embodiments of the present invention are explained in detail in conjunction with drawings.

Here, in all drawings for explaining the embodiments, parts having identical functions are given same symbols, and their repeated explanation is omitted.

[Transflective Liquid Crystal Display Device which Becomes a Premise of the Present Invention]

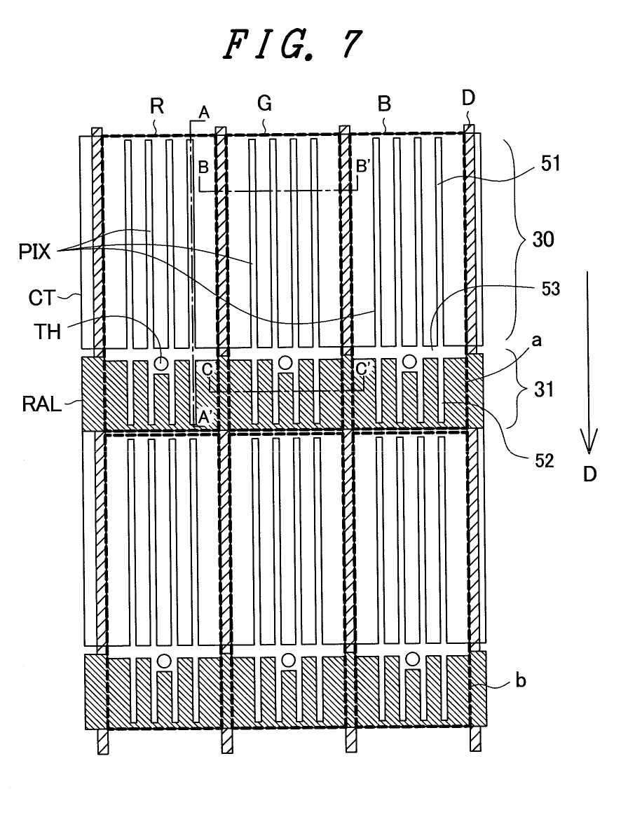

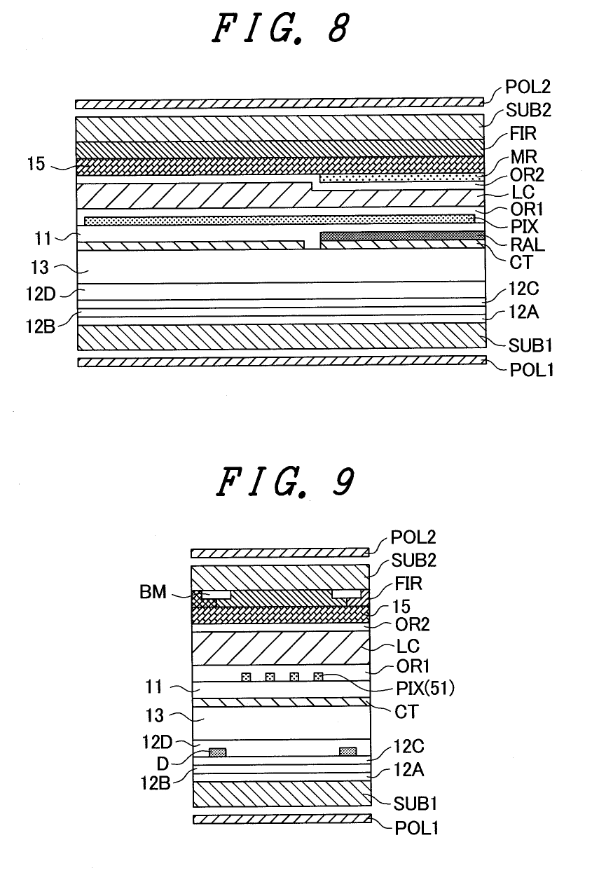

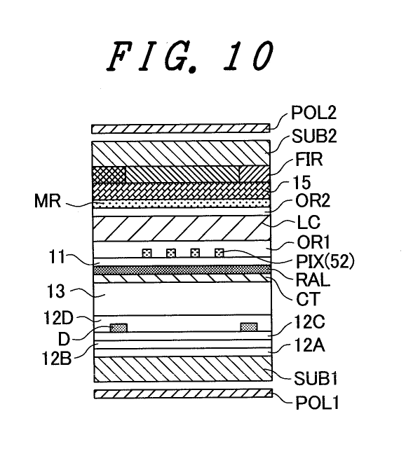

FIG. 7 is a plan view showing the electrode structure of sub pixels of a transflective liquid crystal display device which becomes a premise of the present invention (hereinafter referred to as prior invention), FIG. 8 is a cross-sectional view of an essential part showing the cross-sectional structure taken along a connection line A-A′ in FIG. 7, FIG. 9 is a cross-sectional view of an essential part showing the cross-sectional structure taken along a connection line B-B′ in FIG. 7, and FIG. 10 is a cross-sectional view of an essential part showing the cross-sectional structure taken along a connection line C-C′ in FIG. 7.

Hereinafter, the prior invention is explained in conjunction with FIG. 7 to FIG. 10.

In FIG. 7, numeral 30 indicates transmissive portions which constitute a transmissive liquid crystal display panel and numeral 31 indicates reflective portions which constitute a reflective liquid crystal display panel.

In the prior invention, the transmissive liquid crystal display panel includes a pair of glass substrates (SUB1, SUB2) which sandwich a liquid crystal layer (LC) therebetween. Here, a main surface side of the glass substrate (SUB2) constitutes an observation side.

On a liquid crystal layer side of the glass substrate (SUB2), in order from the glass substrate (SUB1) to the liquid crystal layer (LC), a black matrix (BM), color filter layers (FIR), an insulation film 15, a step forming layer (MR) and an orientation film (OR2) are formed. Here, a polarizer (POL2) is arranged outside the glass substrate (SUB2).

Further, on a liquid crystal layer side of the glass substrate (SUB1), in order from the glass substrate (SUB1) to the liquid crystal layer (LC), interlayer insulation films (12A to 12D), an interlayer insulation film 13, counter electrodes (CT) and a reflection electrodes (RAL), an interlayer insulation film 11, pixel electrodes (PIX) and an orientation film (OR1) are formed. Here, a polarizer (POL1) is also arranged outside the glass substrate (SUB1).

The pixel electrodes (PIX) and the counter electrodes (CT) are, for example, formed of a transparent conductive film such as an ITO (Indium Tin Oxide) film. Further, in this embodiment, the counter electrodes (CT) are formed in a planar shape, while the pixel electrodes (PIX) and the counter electrodes (CT) are overlapped to each other by way of the interlayer insulation film 11 thus forming a holding capacitance.

The step forming layer (MR) is provided for adjusting a cell gap length (d) of the liquid crystal layer (LC) in the reflective portion such that an optical path length of light in the reflective portion becomes an optical path length corresponding to a λ/4 wave plate. Further, although the reflective electrode (RAL) is formed of a metal film made of aluminum (Al), for example, the reflective electrode (RAL) is not limited to such a metal film and the reflective electrode (RAL) may adopt the two-layered structure consisting of a lower layer made of molybdenum (Mo) and an upper layer made of aluminum (Al).

As shown in FIG. 7, the pixel electrode (PIX) includes pixel electrodes 51 in the transmissive portion 30, pixel electrodes 52 in the reflective portion 31 and a strip-like connecting portion 53 which is formed between the pixel electrodes 51 and the pixel electrodes 52. Here, as shown in FIG. 7, the pixel electrodes 51 and the pixel electrodes 52 are respectively formed in a comb-teeth shape, while the pixel electrodes 51 and the pixel electrodes 52 are formed at predetermined pitches. Further, portions which are indicated by dotted frames a, b respectively indicate one sub pixel.

Here, a through hole (TH) for applying a video voltage to the pixel electrode (PIX) is formed in the strip-like connecting portion 53 which constitutes a portion of the pixel electrode (PIX).

Here, in FIG. 7, FIG. 8 and other corresponding drawings, an active matrix is constituted of a plurality of scanning lines (or gate lines) (G), a plurality of video lines (drain lines or source lines) (D) which intersect the plurality of scanning lines and active elements (for example, thin film transistors) which are formed corresponding to the respective sub pixels. However, the illustration of the active matrix is omitted. Further, although contact holes are formed when necessary, the illustration of the contact holes is also omitted. Further, although the counter electrode (CT) is electrically connected with the counter electrode (CT) of the sub pixel of a neighboring column not shown in the drawing, the illustration of the connection structure is also omitted.

In the prior invention, within one sub pixel, although the pixel electrode (PIX) is formed in common, the counter electrode (CT) is independently formed in the transmissive portion 30 and the reflective portion 31 respectively. That is, the counter electrode (CT) is sprit in two for the transmissive portion 30 and the reflective portion 31.

Here, FIG. 7 illustrates a case in which with respect to two neighboring display lines, the counter electrodes (CT) in the reflective portions 31 on one display line (the display line having the sub pixels indicated by “a” in FIG. 7) and the counter electrodes (CT) of the transmissive portions 30 on another display line (display line having the sub pixels indicated by “b” in FIG. 7) are formed by common electrodes. Further, an arrow D in FIG. 7 shows the scanning direction.

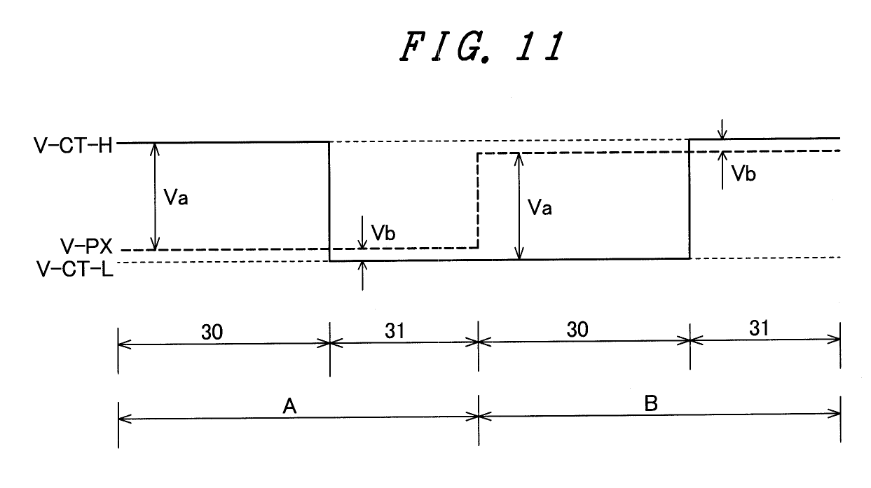

Further, as shown in FIG. 11, in the prior invention, within one sub pixel, different reference voltages are applied to the counter electrode (CT) in the transmissive portion 30 and the counter electrode (CT) in the reflective portion 31.

For example, in the sub pixel indicated by “a” in FIG. 7, the reference voltage (V-CT-H) of High level (hereinafter, referred to as H level) is applied to the counter electrode (CT) in the transmissive portion 30, while the reference voltage (V-CT-L) of Low level (hereinafter, referred to as L level) is applied to the counter electrode (CT) in the reflective portion 31.

Further, in the sub pixel indicated by “a” in FIG. 7, as indicated by “A” in FIG. 11, a video voltage (V-PX) which exhibits the negative polarity as viewed in the transmissive portion 30 and exhibits the positive polarity as viewed in the reflective portion 31 is applied to the pixel electrode (PIX). Here, the negative polarity implies that a potential of the pixel electrode (PIX) is lower than a potential of the counter electrode (CT) and it does not matter whether the potential of the pixel electrode (PIX) is larger or smaller than 0V. In the same manner, the positive polarity implies that the potential of the pixel electrode (PIX) is higher than the potential of the counter electrode (CT) and it does not matter whether the potential of the pixel electrode (PIX) is larger or smaller than 0V.

In the same manner, in the sub pixel indicated by “b” in FIG. 7, as indicated by “B” in FIG. 11, a reference voltage (V-CT-L) of L level is applied to the counter electrode (CT) in the transmissive portion 30 and a reference voltage (V-CT-H) of H level is applied to the counter electrode (CT) in the reflective portion 31. Further, in the sub pixel indicated by “b” in FIG. 7, a video voltage (V-PX) which exhibits positive polarity as viewed in the transmissive portion 30 and exhibits negative polarity as viewed in the reflective portion 31 is applied to the pixel electrode (PIX).

Here, the video voltage (V-PX) applied to the pixel electrode (PIX) is a potential between the reference voltage (V-CT-H) of H level and the reference voltage (V-CT-L) of L level.

Accordingly, in the sub pixels indicated by “a” and “b” in FIG. 7, the potential difference (Va in FIG. 11) between the pixel electrode (PIX) and the counter electrode (CT) in the transmissive portion 30 becomes large, while the potential difference (Vb in FIG. 11) between the pixel electrode (PIX) and the counter electrode (CT) in the reflective portion 31 becomes small.

Accordingly, when the potentials indicated in FIG. 11 are applied, in the transmissive portion 30, the potential difference Va between the pixel electrode (PIX) and the counter electrode (CT) is large and hence, the brightness is increased. Here, in the reflective portion 31, potential difference Vb between the pixel electrode (PIX) and the counter electrode (CT) is small and hence, the brightness is also increased in the same manner.

Then, in the transmissive portion 30, when the potential of the pixel electrode (PIX) (potential of the video signal) is changed to a potential different from the potential indicated in FIG. 11 thus further increasing the potential difference Va between the pixel electrode (PIX) and the counter electrode (CT), in the reflective portion 31, the potential difference Vb between the pixel electrode (PIX) and the counter electrode (CT) is further decreased and hence, the brightness in both of the transmissive portion 30 and the reflective portion 31 is increased.

To the contrary, in the transmissive portion 30, when the potential of the pixel electrode (PIX) (potential of the video signal) is changed to a potential different from the potential indicated in FIG. 11 thus decreasing the potential difference Va between the pixel electrode (PIX) and the counter electrode (CT), in the reflective portion 31, the potential difference Vb between the pixel electrode (PIX) and the counter electrode (CT) is increased and hence, the brightness in both of the transmissive portion 30 and the reflective portion 31 is decreased.

In this manner, in the prior invention, the counter electrode (CT) is sprit in two, that is, into the counter electrode (CT) in the transmissive portion 30 and the counter electrode (CT) in the reflective portion 31 within one sub pixel, and the reference voltages having polarities opposite to each other (here, polarities opposite to each other implying that when one reference voltage assumes H level, another reference voltage assumes L level) are applied to the counter electrode (CT) in the transmissive portion 30 and the counter electrode (CT) in the reflective portion 31 and hence, it is possible to prevent the contrast from being reversed between the transmissive portion 30 and the reflective portion 31. That is, in the prior invention, irrespective of the fact that the transmissive portion 30 performs a display in a normally black mode and the reflective portion 31 performs a display in a normally white mode, by adjusting the voltage applied to the counter electrode (CT) in the reflective portion 31, a drawback on the inversion of contrast is overcome.

### EMBODIMENT 1

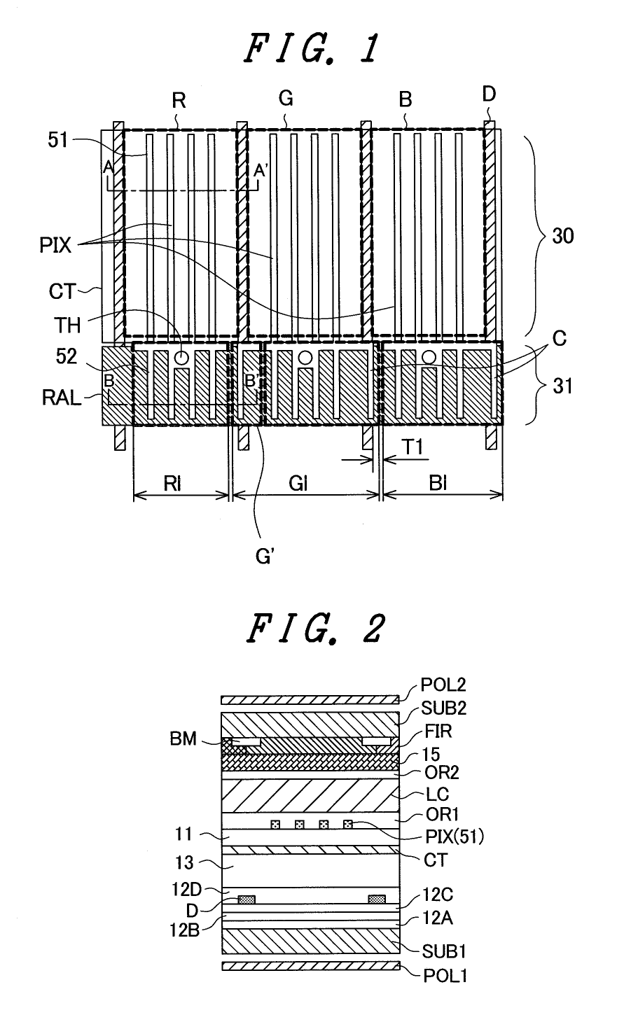

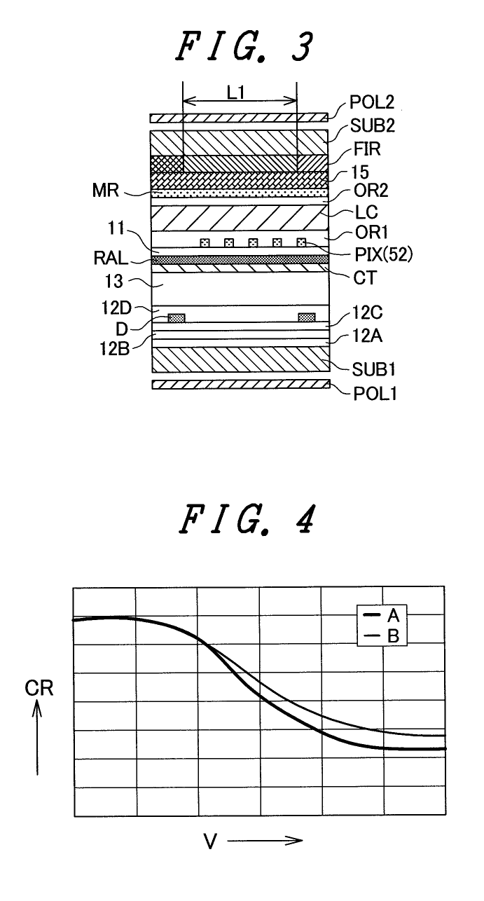

FIG. 1 is a plan view showing the electrode structure of sub pixels of a transflective liquid crystal display device of an embodiment 1 according to the present invention. FIG. 2 is a cross-sectional view of an essential part showing the cross-sectional structure taken along a connection line A-A′ in FIG. 1, and FIG. 3 is a cross-sectional view of an essential part showing the cross-sectional structure taken along a connection line B-B′ in FIG. 1.

It is known that display efficiency is changed corresponding to a width or a distance of the pixel electrodes formed in a comb-teeth shape and there exists a range of sizes of the pixel electrodes which can enhance the display efficiency. On the other hand, in a display element having high definition used in a mobile phone or the like, a size of one sub pixel is small and hence, it is difficult to ensure such sizes which can enhance the display efficiency. In view of the above, a portion to which an electric field is hardly applied is generated and hence a white blank portion is generated at the time of performing a black display.

In the prior invention, as shown in FIG. 7, the pixel electrodes 52 in the reflective portion 31 which are formed in a comb-teeth shape are arranged to be accommodated in a rectangular sub pixel region and hence, at an end portion of the sub pixel region, there exists a portion where the pixel electrode 52 is not arranged thus making the application of an electric field difficult. Accordingly, there exists a possibility that the sufficient switching to the black cannot be performed at the portion to which the electric field is hardly applied thus leaving a white portion leading to the lowering of contrast.

In this embodiment, the sub pixels of R (red), G (green), B (blue) in the reflective portion 31 constitutes one region, the pixel electrodes 52 which are formed in a comb-teeth shape with a pitch closer to an equal pitch than the pitch of the pixel electrodes 52 shown in FIG. 7 are arranged in such a region and hence, the portion to which the electric field is hardly applied is largely reduced thus improving the black level.

Here, this embodiment is characterized by freely arranging the pixel electrodes 52 in the reflective portion 31 by changing the width, the distance and the number of the pixel electrodes 52 without taking the arrangement of the conventional sub pixel region into consideration too much. Further, along with this change of arrangement, the shapes of color filters are changed between the transmissive portion 30 and the reflective portion 31 thus allowing the color filters to conform with the regions of the pixel electrodes 52 in the reflective portion 31.

Due to such a constitution, the reflective portion 31 of this embodiment has following technical features.

(1) As indicated by “C” in FIG. 1, portions of the pixel electrodes 52 in the reflective portion 31 of the sub pixel of G or B are arranged on the video line (D).

That is, when the pixel electrodes 52 in the reflective portion 31 and the video line (D) are projected to one substrate (SUB1) from the direction orthogonal to a main surface of the liquid crystal display panel, the portions of the pixel electrodes 52 in the reflective portion 31 are overlapped to the video line (D).

(2) A length (L1 in FIG. 3) of the color filter in the first direction in the reflective portion 31 of the sub pixel of R is made different from a length of the color filter in the first direction in the transmissive portion 30 of the sub pixel of R.

(3) As indicated by T1 in FIG. 1, shapes of color filters in the reflective portions 31 of the sub pixels of R, G, B are displaced in the first direction with respect to the shapes of color filters in the transmissive portion 30.

Here, the first direction is the direction along one horizontal display line. Here, the color filters of the same color are arranged in the second direction (orthogonal to the first direction).

(4) The numbers of the pixel electrodes 52 in the reflective portion 31 of the sub pixels of R, G, B are made different from each other for the respective sub pixels of R, G, B. For example, in FIG. 1, the number of the pixel electrodes 52 in the reflective portion 31 of the sub pixel of R is 4, the number of the pixel electrodes 52 in the reflective portion 31 of the sub pixel of G is 6, and the number of the pixel electrodes 52 in the reflective portion 31 of the sub pixel of B is 5.

That is, in FIG. 1, assuming the numbers of the pixel electrodes 52 in the reflective portions 31 of the sub pixels of R, G, B as Ra, Ga, Ba respectively, a relationship of Ga>Ba>Ra is satisfied.

(5) Lengths of the sub pixels of R, G, B in the first direction in the reflective portion 31 are made different from each other for respective sub pixels of R, G, B. For example, in FIG. 1, assuming the lengths of the respective sub pixels of R, G, B in the first direction in the reflective portion 31 as Rl, Gl, Bl, a relationship of Gl>Bl>Rl is satisfied.

Here, although FIG. 1 shows the case in which the color filter of G is also formed in a portion G′, the present invention is not limited to such a case and an opening (a color filter non-forming region) may be formed in the portion G′. In this case, the brightness of the display at the time of performing a white display can be increased.

FIG. 4 shows a voltage-reflectance characteristic (A in FIG. 4) of the reflective portion 31 in the transflective liquid crystal display device of this embodiment and a voltage-reflectance characteristic (B in FIG. 4) of the reflective portion 31 in the prior invention. Here, in FIG. 4, a potential difference (V) between the counter electrode (CT) and the pixel electrode 52 is taken on an axis on abscissas, and the reflective brightness (CR) is taken on an axis of ordinates.

As shown in FIG. 4, in this embodiment, it is possible to lower the reflectance of black thus enhancing the black level.

### EMBODIMENT 2

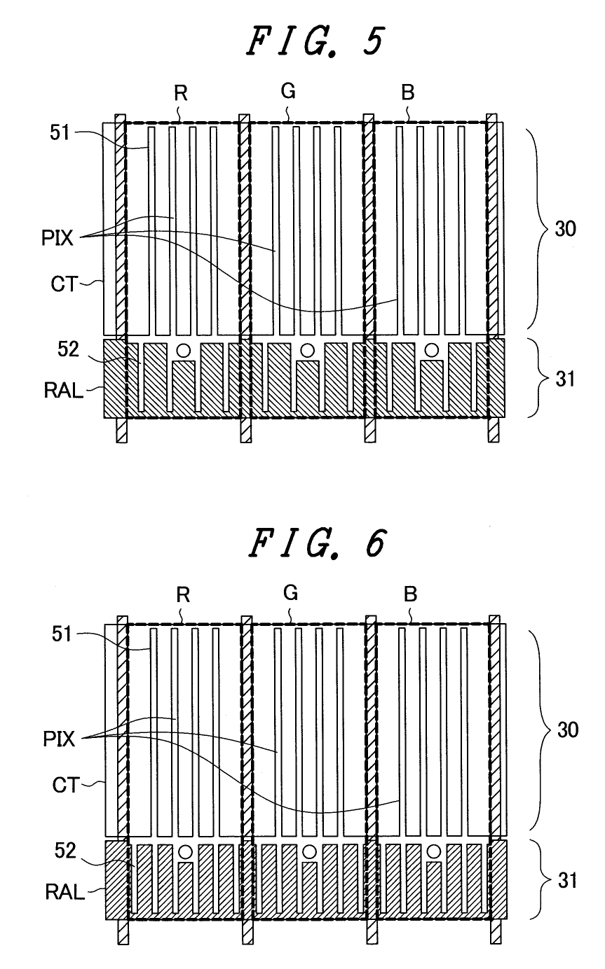

FIG. 5 is a plan view showing the electrode structure of sub pixels of a modification of a transflective liquid crystal display device of an embodiment 2 according to the present invention.

In this embodiment, in the same manner as the related art, the pixel electrode (PIX) is arranged within a range of one sub pixel region. This embodiment is characterized by arranging the position of the pixel electrode closer to the neighboring sub pixel.

That is, as shown in FIG. 5, in this embodiment, a distance between the pixel electrode 52 and the video line (D) in the reflective portions 31 of the sub pixels of R, G, B is set smaller than a distance between the pixel electrode 51 and the video line (D) in the transmissive portion 30.

Further, in this embodiment, the distance between the comb-teeth shaped pixel electrodes (51, 52) is also changed between the transmissive portion 30 and the reflective portion 31.

Here, as in the case of this embodiment, when the pixel electrode is arranged at a position closer to the neighboring sub pixel, an electric field influences the neighboring pixel thus giving rise to a side effect such as color mixing. However, the reflective portion 31 possesses the normally white characteristic and hence, when the potential difference between the pixel electrode 52 and the counter electrode (CT) is increased, the reflective portion 31 performs a “black” display. Accordingly, even when the electric field extends to the neighboring pixel, no side effect such as color mixing is generated.

### EMBODIMENT 3

FIG. 6 is a plan view showing the electrode structure of sub pixels of a modification of a transflective liquid crystal display device of an embodiment 3 according to the present invention.

In this embodiment, in the same manner as the related art, the pixel electrode (PIX) is arranged within a range of one sub pixel region. However, o the number of the pixel electrodes 51 in the transmissive portion 30 of the sub pixel of R, G, B and the number of pixel electrodes 52 in the reflective portion 31 of the sub pixel of R, G, B differ from each other.

In FIG. 6, the number of the pixel electrodes 51 in the transmissive portion 30 of the sub pixel of R, G, B is 4, while the number of pixel electrodes 52 in the reflective portion 31 of the sub pixel of R, G, B is 6. Due to such a constitution, the distance between the pixel electrodes 52 is set smaller than the distance between the pixel electrodes 51. Further, in the same manner as the above-mentioned embodiment 2, the distance between the pixel electrode 52 in the reflective portion 31 of the sub pixel of R, G, B and the video line (D) is set smaller than the distance between the pixel electrode 51 in the transmissive portion 30 and the video line (D).

Here, in the above-mentioned description, the explanation has been made with respect to the embodiments which are applied to sub pixels of R, G, B. However, the present invention is not limited to such embodiments and the present invention is also applicable to sub pixels of C (cyan), M (magenta) and Y (yellow).

Although the inventions made by inventors of the present invention have been specifically explained in conjunction with the embodiments, it is not needless to say that the present invention is not limited to the above-mentioned embodiments and various modifications are conceivable without departing from the gist of the present invention.

1. (canceled)

2. A transflective liquid crystal display device including a liquid crystal display panel, the liquid crystal display panel comprising:
a pair of substrates;
liquid crystal which is sandwiched between the pair of substrates;
a plurality of sub pixels each of which includes a transmissive portion and a reflective portion; each sub pixel having a pixel electrode formed on one substrate out of the pair of substrates and a counter electrode formed on the one substrate, the pixel electrode being arranged in common in the transmissive portion and the reflective portion and the counter electrode being arranged individually in the transmissive portion and the reflective portion in one sub pixel, the pixel electrode and the counter electrode generating an electric field therebetween thus driving the liquid crystal, wherein
the liquid crystal display panel includes color filters, and
a length of the color filter in the first direction in the reflective portion of at least one sub pixel out of the plurality of sub pixels is set different from a length of the color filter in the first direction in the transmissive portion of the at least one sub pixel.

3. A transflective liquid crystal display device including a liquid crystal display panel, the liquid crystal display panel comprising:
a pair of substrates;
liquid crystal which is sandwiched between the pair of substrates;
a plurality of sub pixels each of which includes a transmissive portion and a reflective portion; each sub pixel having a pixel electrode formed on one substrate out of the pair of substrates and a counter electrode formed on the one substrate, the pixel electrode being arranged in common in the transmissive portion and the reflective portion and the counter electrode being arranged individually in the transmissive portion and the reflective portion in one sub pixel, the pixel electrode and the counter electrode generating an electric field therebetween thus driving the liquid crystal, wherein
the liquid crystal display panel includes color filters, and
a shape of the color filter in the reflective portion of at least one sub pixel out of the plurality of sub pixels is displaced in the first direction with respect to a shape of the color filter in the transmissive portion.

4. A transflective liquid crystal display device including a liquid crystal display panel, the liquid crystal display panel comprising:
a pair of substrates;
liquid crystal which is sandwiched between the pair of substrates;
a plurality of sub pixels each of which includes a transmissive portion and a reflective portion; each sub pixel having a pixel electrode formed on one substrate out of the pair of substrates and a counter electrode formed on the one substrate, the pixel electrode being arranged in common in the transmissive portion and the reflective portion and the counter electrode being arranged individually in the transmissive portion and the reflective portion in one sub pixel, the pixel electrode and the counter electrode generating an electric field therebetween thus driving the liquid crystal, wherein
the numbers of pixel electrodes in the reflective portions of the sub pixels of first color, second color and third color out of the plurality of sub pixels differ from each other for the respective sub pixels of the first color, the second color and the third color.

5. A transflective liquid crystal display device according to claim 4, wherein the first color is red, the second color is green and the third color is blue, and
assuming the numbers of the pixel electrodes in the reflective portions of the sub pixels of red, green and blue as Ra, Ga, Ba, a relationship Ga>Ba>Ra is established.

6. A transflective liquid crystal display device including a liquid crystal display panel, the liquid crystal display panel comprising:
a pair of substrates;
liquid crystal which is sandwiched between the pair of substrates;
a plurality of sub pixels each of which includes a transmissive portion and a reflective portion; each sub pixel having a pixel electrode formed on one substrate out of the pair of substrates and a counter electrode formed on the one substrate, the pixel electrode being arranged in common in the transmissive portion and the reflective portion and the counter electrode being arranged individually in the transmissive portion and the reflective portion in one sub pixel, the pixel electrode and the counter electrode generating an electric field therebetween thus driving the liquid crystal, wherein
the liquid crystal display panel includes video lines, and
a distance between the pixel electrode in the reflective portion of at least one sub pixel out of the plurality of sub pixels and the video line is set smaller than a distance between the pixel electrode in the transmissive portion of the at least one sub pixel and the video line.

7. A transflective liquid crystal display device including a liquid crystal display panel, the liquid crystal display panel comprising:
a pair of substrates;
liquid crystal which is sandwiched between the pair of substrates;
a plurality of sub pixels each of which includes a transmissive portion and a reflective portion; each sub pixel having a pixel electrode formed on one substrate out of the pair of substrates and a counter electrode formed on the one substrate, the pixel electrode being arranged in common in the transmissive portion and the reflective portion and the counter electrode being arranged individually in the transmissive portion and the reflective portion in one sub pixel, the pixel electrode and the counter electrode generating an electric field therebetween thus driving the liquid crystal, wherein
the lengths in the first direction of the sub pixels of first color, second color and third color out of the plurality of sub pixels in the reflective portions differ from each other for the respective sub pixels of the first color, the second color and the third color.

8. A transflective liquid crystal display device according to claim 7, wherein the first color is red, the second color is green and the third color is blue, and
assuming the lengths in the first direction of the sub pixels of red, green and blue in the reflective portions as Rl, Gl, Bl, a relationship Gl>Bl>Rl is established.

9. A transflective liquid crystal display device according to claim 2, wherein the first direction is a direction along one horizontal display line.

10-15. (canceled)
